(19) United States
(12) Patent Application Publication
(10) Pub. No.: US 2026/0296050 A1
(43) Pub. Date: Oct. 1, 2026

(54) THERMAL PRINT HEAD AND THERMAL PRINTER

(71) Applicant: ROHM CO., LTD., Kyoto (JP)

(72) Inventors: Toshihiro KIMURA, Kyoto (JP); Yasuhiro YOSHIKAWA, Kyoto (JP)

(21) Appl. No.: 19/576,049

(22) Filed: Mar. 24, 2026

(30) Foreign Application Priority Data
Mar. 31, 2025 (JP) 2025-058005

(51) Int. Cl. B41J 2/335; B41J 2/325; B41J 2/36

(52) U.S. Cl. CPC B41J 2/3351; B41J 2/325; B41J 2/3352; B41J 2/3354; B41J 2/36

(57) ABSTRACT

A thermal print head includes a common electrode, a plurality of individual electrodes, and a plurality of heat-generators disposed between the common electrode and the individual electrodes, wherein the individual electrodes include a plurality of first electrodes each having a width W1, which is a size in an X-axis direction, at a portion adjacent to a corresponding one of the heat-generators, and a plurality of second electrodes each having a width W2, which is a size in the X-axis direction and shorter than the width W1, at a portion adjacent to a corresponding one of the heat-generators, wherein the individual electrodes are arranged in a pattern in which a basic pattern is repeated along the X-axis direction, and wherein in the basic pattern, one of the first electrodes, two of the second electrodes, and one of the first electrodes are arranged sequentially along the X-axis direction.

### CROSS-REFERENCE TO RELATED APPLICATION

This application is based upon and claims the benefit of priority from Japanese Patent Application No. 2025-058005, filed on Mar. 31, 2025, the entire content of which is incorporated herein by reference.

### TECHNICAL FIELD

The present disclosure relates to a thermal print head and a thermal printer including the thermal print head.

### BACKGROUND

Conventionally, a thermal print head including a common electrode, a plurality of individual electrodes, and a plurality of heat-generators respectively disposed between the common electrode and the plurality of individual electrodes is known. This thermal print head is capable of performing printing on a print medium by causing the heat-generators to generate heat through energization of the plurality of heat-generators.

### BRIEF DESCRIPTION OF DRAWINGS

The accompanying drawings, which are incorporated in and constitute a part of the specification, illustrate embodiments of the present disclosure.

FIG. 1 is a diagram schematically illustrating a configuration of a thermal printer including a thermal print head.

FIGS. 2A and 2B are diagrams illustrating states of printing using the thermal print head.

FIG. 3 is a plan view schematically illustrating the thermal print head.

FIG. 4 is a partially enlarged plan view illustrating a main part of the thermal print head.

FIG. 5 is a diagram illustrating a control image in a first mode (300dpi).

FIG. 6 is a diagram illustrating a control image in a second mode (200dpi).

FIG. 7A is a diagram illustrating a printing image in the first mode (300dpi), and FIG. 7B is a diagram illustrating a printing image in the second mode (200dpi).

FIG. 8 is a flowchart illustrating an example of a procedure of setting a control mode of the thermal printer by a controller.

FIG. 9 is a diagram illustrating a control image according to a number of energizations in the second mode (200dpi).

FIG. 10 is a partially enlarged plan view illustrating a main part of a thermal print head.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

The details of embodiments of the present disclosure will be described below with reference to the drawings. In the drawings described below, same or corresponding parts are denoted by same reference numerals, and redundant descriptions thereof will be omitted. At least some configurations of the embodiments described below may be arbitrarily combined.

### Overall Configuration

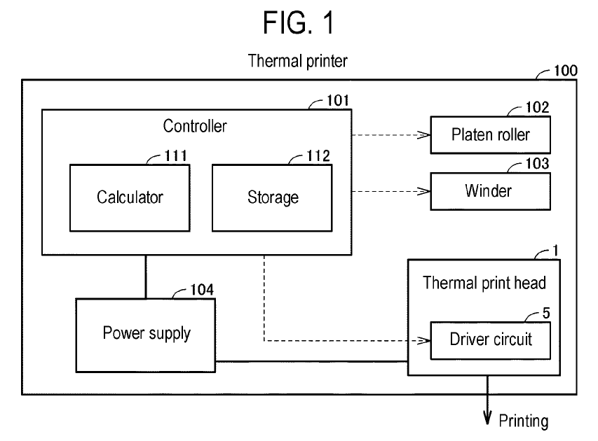

FIG. 1 is a diagram schematically illustrating a configuration of a thermal printer 100 including a thermal print head 1 according to a present embodiment. The thermal printer 100 includes the thermal print head 1, a controller 101, a platen roller 102, a winder 103, and a power supply 104. The power supply 104 supplies an electric current to the thermal print head 1 and the controller 101.

The thermal print head 1 performs printing on a print medium by heat generation. In general, thermal print heads are classified into different types such as a thick-film type, a thin-film type, and a special type in which a heat-generating substrate is formed in a three-dimensional shape by special processing, according to differences in manufacturing methods, substrates forming a heat-generating body, other constituent materials, and product structures. However, the thermal print head 1 according to the present embodiment is applicable to any of these types.

The thermal print head 1 includes a driver circuit 5. The driver circuit 5 includes a plurality of switching elements for respectively controlling energization of a plurality of heat-generators. The driver circuit 5 switches states of the plurality of switching elements to an ON (conductive) state or an OFF (non-conductive) state based on signals from the controller 101 to control the energization of the plurality of heat-generators, thereby performing printing on the print medium.

The platen roller 102 is a component controlled by the controller 101 to convey the print medium from a paper-feeding side to a paper-discharging side, and is pressed against the thermal print head 1 via the print medium when the thermal print head 1 performs printing on the print medium. The thermal printer includes a thermal printer that performs color development printing (thermal printing) by heat of the print medium and a thermal printer that performs thermal transfer printing via an ink ribbon. In the case of thermal transfer printing, the winder 103 is controlled by the controller 101 and serves as a mechanism for winding the ink ribbon after transfer.

The controller 101 includes a calculator 111 and a storage 112. The calculator 111 is a calculation entity (computer) that executes predetermined processing. The calculator 111 is constituted by, for example, a processor such as a micro-controller unit (MCU), a central processing unit (CPU), a micro-processing unit (MPU), a tensor processing unit (TPU), or a graphics processing unit (GPU).

The storage 112 is implemented by storage devices such as a random access memory (RAM), a read only memory (ROM), a nonvolatile memory such as a flash memory, and magnetic disks. The storage 112 stores programs executed by the calculator 111 or data used by the calculator 111. The storage 112 may be interpreted as a processing circuitry having a function of holding data or signals.

The calculator 111 calculates energization signals to be transmitted to the driver circuit 5 based on information stored in the storage 112. The energization signals are command signals for controlling the energization of the plurality of heat-generators (the states of the switching elements of the driver circuit 5) to be described later. The thermal print head 1 performs printing on the print medium based on the energization signals transmitted from the controller 101 to the driver circuit 5.

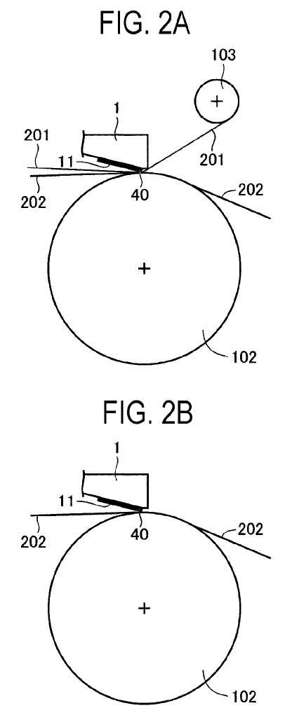

FIGS. 2A and 2B are diagrams illustrating states of printing using the thermal print head 1. The thermal print head 1 is disposed to face the platen roller 102 which is formed in a cylindrical shape. The print medium is interposed between a heat-generator 40 of the thermal print head 1 and the platen roller 102. As illustrated in FIG. 2A, the print medium according to the present embodiment is constituted by an ink ribbon 201 and a paper 202, and is conveyed from the paper-feeding side to the paper-discharging side by rotation of the platen roller 102. Thermal energy generated by the heat-generator 40 of the thermal print head 1 melts ink of the ink ribbon 201 and transfers the ink onto the paper 202. The winder 103 is a device for winding the ink ribbon 201 after the transfer. Alternatively, the print medium may be a thermal paper that is coated with chemicals that change color through a chemical reaction when sensing heat. As illustrated in FIG. 2B, when the print medium is the thermal paper, the ink ribbon 201 and the winder 103 are unnecessary.

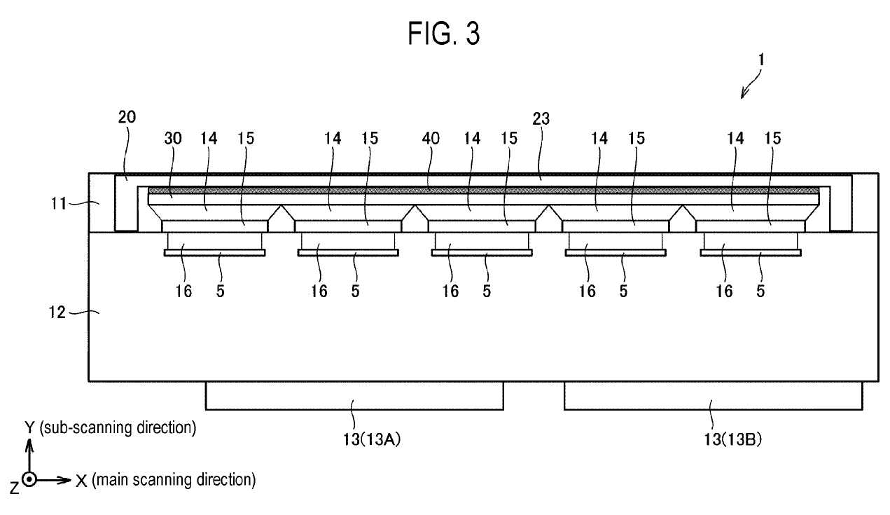

FIG. 3 is a plan view schematically illustrating the thermal print head 1. The thermal print head 1 is formed in a flat plate shape and is rectangular in a plan view. Hereinafter, in a plan view of the thermal print head 1, a longitudinal direction of the thermal print head 1 is also referred to as an "X-axis direction," a lateral direction thereof is also referred to as a "Y-axis direction," and a thickness direction thereof is also referred to as a "Z-axis direction." The X-axis direction is also referred to as a "main scanning direction," and the Y-axis direction is also referred to as a "sub-scanning direction."

The thermal print head 1 includes, in addition to the driver circuit 5, a substrate 11, a circuit board 12, a connector 13, a wiring 14, a pad 15, a wire 16, a common electrode 20, an individual electrode 30, and a heat-generator 40. The connector 13 includes a connector 13A for control and a connector 13B for power supply. The thermal print head 1 is connected to the controller 101 via the connector 13A and to the power supply 104 via the connector 13B.

The substrate 11 and the circuit board 12 are flat plate members elongated in the X-axis direction. The common electrode 20, the individual electrode 30, the heat-generator 40, the wiring 14, and the pad 15 are provided over the substrate 11. The wire 16 is provided to extend from the substrate 11 to the circuit board 12, and the driver circuit 5 is provided over the circuit board 12. Although not illustrated in FIG. 3, the wire 16 and the driver circuit 5 are covered with resin for protection.

The common electrode 20 and the individual electrode 30 are formed of a conductive material and constitute a conduction path for supplying a current to the heat-generator 40. The heat-generator 40 is formed of a resistive body and generates heat when a current flows therethrough. The common electrode 20 and the individual electrode 30 are made of metallic materials having lower resistances than the heat-generator 40. For example, the common electrode 20 and the individual electrode 30 may include a layer made of copper (Cu), aluminum (Al), or gold (Au), and a layer made of titanium (Ti). The heat-generator 40 may be made of tantalum nitride (TaN).

The common electrode 20 includes a base 23 disposed to extend along a surface of the substrate 11 in the X-axis direction. The individual electrode 30 is disposed at a position spaced apart from the base 23 of the common electrode 20 by a predetermined distance in a negative Y-axis direction. The heat-generator 40 is disposed between the common electrode 20 and the individual electrode 30.

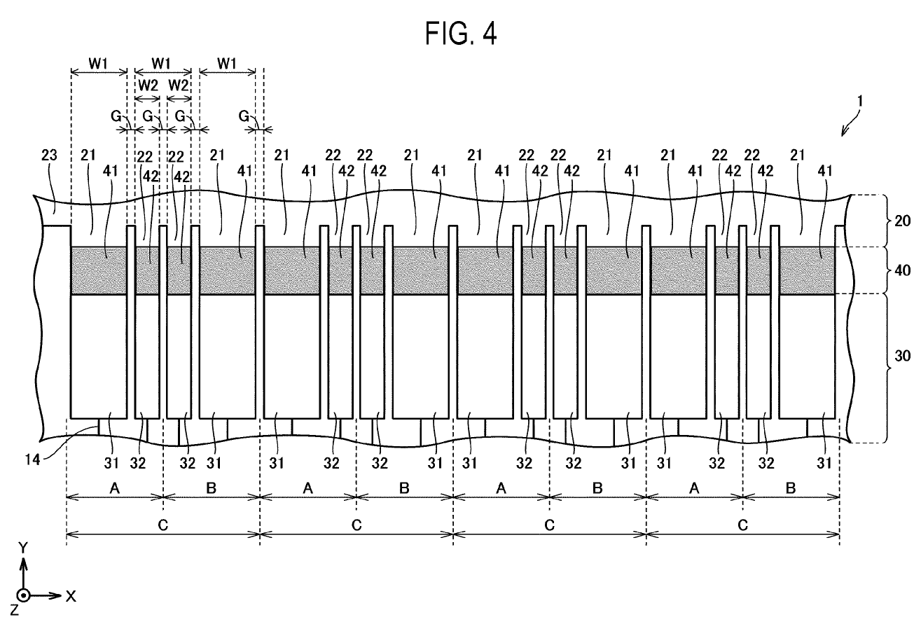

Although not illustrated in FIG. 3, the individual electrode 30 is constituted by a plurality of individual electrodes arranged in the X-axis direction at predetermined intervals. The wiring 14 is constituted by a plurality of conductive members that respectively connect the plurality of individual electrodes and a plurality of connection pads constituting the pad 15. The heat-generator 40 is constituted by a plurality of heat-generators that are respectively disposed between the common electrode 20 and the plurality of individual electrodes constituting the individual electrode 30. Details of shapes and arrangements of the common electrode 20, the individual electrode 30, and the heat-generator 40 will be described later with reference to FIG. 4.

The wire 16 is constituted by a plurality of connection wires that respectively connect the plurality of connection pads constituting the pad 15 and a plurality of switching elements included in the driver circuit 5. Accordingly, the individual electrode 30 is connected to the plurality of switching elements included in the driver circuit 5 via the wire 16.

FIG. 4 is a partially enlarged plan view illustrating a main part (the common electrode 20, the individual electrode 30, and the heat-generator 40) of the thermal print head 1. As illustrated in FIG. 4, the individual electrode 30 is constituted by a plurality of individual electrodes arranged in the X-axis direction at predetermined intervals. Each of the plurality of individual electrodes extends in the Y-axis direction. The plurality of individual electrodes are respectively connected to the plurality of switching elements included in the driver circuit 5 via the wiring 14.

The individual electrode 30 includes, as the plurality of individual electrodes, a plurality of first electrodes 31 and a plurality of second electrodes 32. A width (size in the X-axis direction) of each first electrode 31 is different from a width of each second electrode 32. The width of each first electrode 31 is set to a width W1 corresponding to a width of one dot when a printing resolution is 300 dpi. The width of each second electrode 32 is set to a width W2 which is narrower than the width W1. When a width of a gap between adjacent individual electrodes is defined as a "gap G," the width W2 of each second electrode 32 is set to a value that satisfies a relational expression of "W2+G+W2=W1" (that is, a value such that a sum of a value larger than the width W2 (more specifically, twice the width W2) and the gap G substantially matches the width W1 of each first electrode 31). As long as the above relational expression is satisfied, shapes of each first electrode 31 and each second electrode 32 are not limited to rectangular shapes and may be irregular shapes.

The plurality of individual electrodes constituting the individual electrode 30 are arranged in a pattern where a basic pattern C, in which one first electrode 31, two second electrodes 32, and one first electrode 31 are arranged sequentially in this order in the X-axis direction, is repeatedly arranged along the X-axis direction. Each basic pattern C includes a first pattern A in which one first electrode 31 and one second electrode 32 are arranged sequentially in this order in the positive X-axis direction, and a second pattern B in which one second electrode 32 and one first electrode 31 are arranged sequentially in this order in the positive X-axis direction. The first pattern A and the second pattern B are line-symmetrical with each other with respect to a line extending in the Y-axis direction through a center of the basic pattern C in the X-axis direction.

The heat-generator 40 is constituted by the plurality of heat-generators that are respectively disposed between the common electrode 20 and the plurality of individual electrodes. Specifically, the heat-generator 40 includes, as the plurality of heat-generators, a plurality of first heat-generators 41 and a plurality of second heat-generators 42. The plurality of first heat-generators 41 are respectively disposed between the common electrode 20 and the plurality of first electrodes 31. A width (size in the X-axis direction) of each first heat-generator 41 is the same as the width W1 of each first electrode 31. The plurality of second heat-generators 42 are respectively disposed between the common electrode 20 and the plurality of second electrodes 32. A width (size in the X-axis direction) of each second heat-generator 42 is the same as the width W2 of each second electrode 32.

The common electrode 20 illustrated in FIG. 4 is constituted by the base 23 extending in the X-axis direction, a plurality of first protrusions 21 each extending in the Y-axis direction from the base 23 toward each first heat-generator 41, and a plurality of second protrusions 22 each extending in the Y-axis direction from the base 23 toward each second heat-generator 42. A width (size in the X-axis direction) of each first protrusion 21 is the width W1, and a width (size in the X-axis direction) of each second protrusion 22 is the width W2.

With the configuration described above, the thermal print head 1 according to the present embodiment is capable of printing at two types of resolutions of 200dpi and 300dpi. Hereinafter, control for printing a print pattern, in which black and white are alternately repeated in the X-axis direction (main scanning direction), at the two types of resolutions of 200dpi and 300dpi by using the thermal print head 1 will be described.

### Printing at Two Types of Resolutions Using Thermal Print Head 1

The controller 101 according to the present embodiment is configured to be capable of switching a control mode of the thermal printer 100 including the thermal print head 1 between a first mode in which a printing resolution is set to 300dpi (first resolution) and a second mode in which a printing resolution is set to 200dpi (second resolution), which is lower than 300dpi.

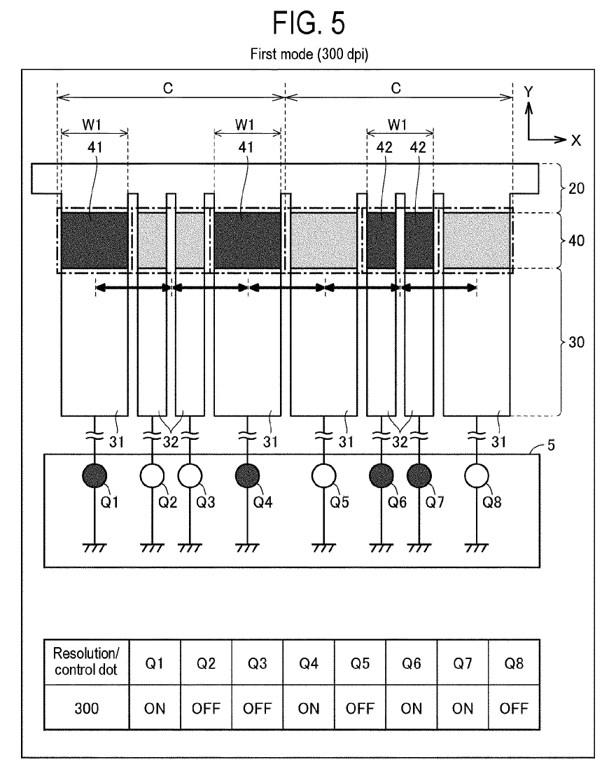

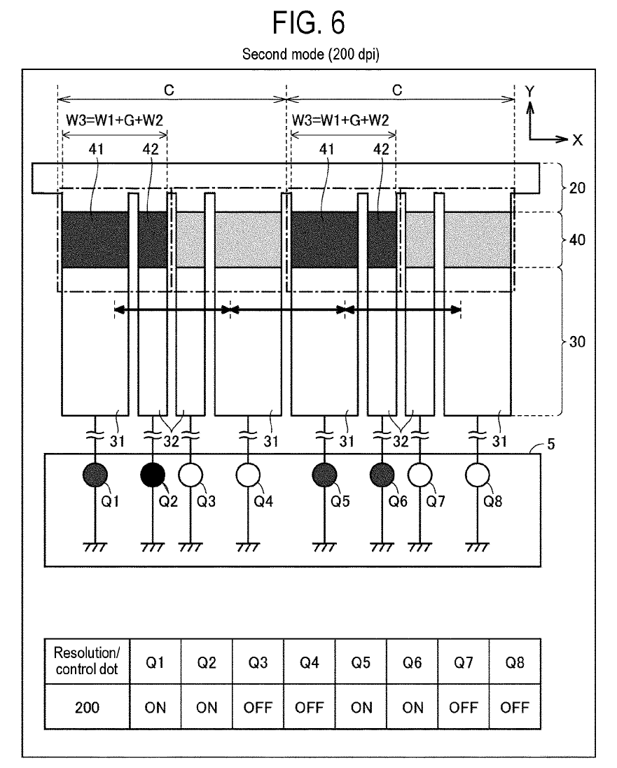

FIG. 5 is a diagram illustrating a control image in the first mode in which the printing resolution is set to 300 dpi. FIG. 6 is a diagram illustrating a control image in the second mode in which the printing resolution is set to 200 dpi. In FIGS. 5 and 6, in order to simplify the explanation, eight individual electrodes included in two basic patterns C are illustrated as the individual electrode 30, and eight switching elements Q1 to Q8 of the driver circuit 5 respectively connected to the eight individual electrodes are illustrated.

In the first mode (300dpi), the controller 101 performs printing of one dot at 300dpi by turning one switching element connected to one first electrode 31, or two switching elements respectively connected to two adjacent second electrodes 32 to the ON (conductive) state. For example, as illustrated in FIG. 5, the controller 101 turns on the switching element Q1 to cause one first heat-generator 41 connected to the switching element Q1 to generate heat, thereby performing printing of the width W1. Further, the controller 101 turns on the switching element Q4 to cause the first heat-generator 41 connected to the switching element Q4 to generate heat, thereby performing printing of the width W1. Further, the controller 101 turns on the switching elements Q6 and Q7 to cause two adjacent second heat-generators 42 respectively connected to the switching elements Q6 and Q7 to generate heat, thereby performing printing of the width W1. Further, a distance (length of each thick arrow) in the X-axis direction between centers of portions, each corresponding to a size of one-dot surrounded by a one-dot chain line indicated in FIG. 5, follows the resolution in the X-axis direction in the first mode (300 dpi). In the case of 300 dpi, the center-to-center distance illustrated in FIG. 5 is approximately 0.0847 mm.

In the second mode (200dpi), the controller 101 performs printing of one dot at 200dpi by turning two switching elements respectively connected to the adjacent first electrode 31 and second electrode 32 to the conductive state. For example, as illustrated in FIG. 6, the controller 101 turns on the switching elements Q1 and Q2 to cause the adjacent first heat-generator 41 and second heat-generator 42 respectively connected to the switching elements Q1 and Q2 to generate heat, thereby performing printing of a width W3. The width W3 is a sum of the width W1, the gap G, and the width W2. The controller 101 also turns on the switching elements Q5 and Q6 to cause the adjacent first heat-generator 41 and second heat-generator 42 respectively connected to the switching elements Q5 and Q6 to generate heat, thereby performing printing of the width W3. Further, a distance (length of each thick arrow) in the X-axis direction between centers of portions, each corresponding to a size of one-dot surrounded by a one-dot chain line indicated in FIG. 6, follows the resolution in the X-axis direction in the second mode (200 dpi). In the case of 200 dpi, the center-to-center distance illustrated in FIG. 6 is approximately 0.125 mm.

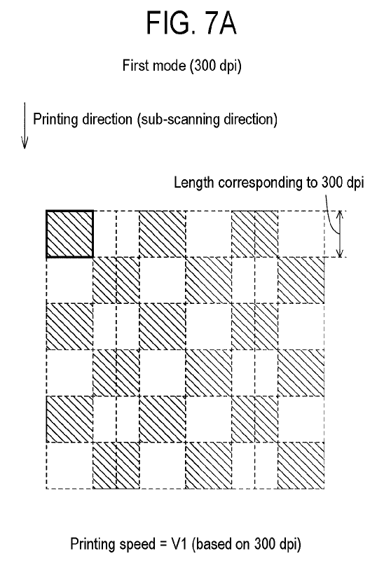

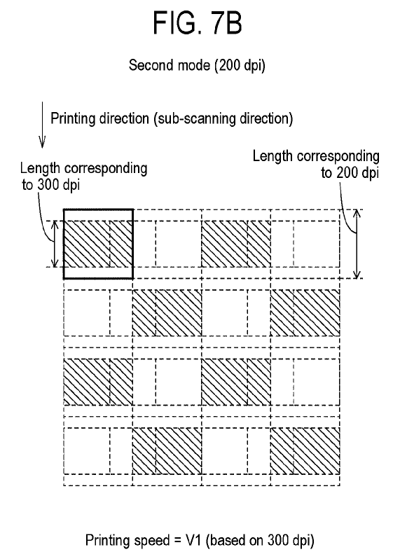

FIG. 7A is a diagram illustrating a printing image in the first mode (300dpi), and FIG. 7B is a diagram illustrating a printing image in the second mode (200dpi). In FIGS. 7A and 7B, each hatched portion indicates a printing of one dot. As illustrated in FIGS. 7A and 7B, the thermal printer 100 according to the present embodiment can perform printing at 300 dpi and printing at 200 dpi by using a single thermal print head 1. Further, FIGS. 7A and 7B illustrate an example in which, in both the first mode and the second mode, a printing speed (a speed at which the print medium is conveyed in the sub-scanning direction) is set to a printing speed V1 based on 300dpi.

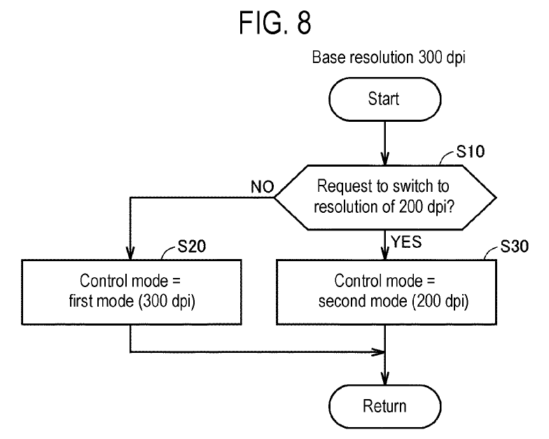

FIG. 8 is a flowchart illustrating an example of a procedure of setting the control mode of the thermal printer 100 by the controller 101. This flowchart is repeatedly executed at a predetermined period during operation of the thermal printer 100. Further, FIG. 8 illustrates an example based on the resolution of 300dpi.

First, the controller 101 determines whether or not there is a request to switch to the resolution of 200dpi (step S10). For example, when the controller 101 detects that a user of the thermal printer 100 has performed an operation to set the printing resolution to 200dpi, the controller 101 determines that there is a request to switch to the resolution of 200dpi.

When there is no request to switch to the resolution of 200dpi (NO in step S10), the controller 101 sets the control mode of the thermal printer 100 to the above-described first mode (300dpi) (step S20).

When there is a request to switch to the resolution of 200dpi (YES in step S10), the controller 101 sets the control mode of the thermal printer 100 to the above-described second mode (200dpi) (step S30).

As described above, the thermal print head 1 according to the present embodiment includes, as the plurality of individual electrodes, the plurality of first electrodes 31 each having the width W1 corresponding to the width of one dot at 300dpi, and the plurality of second electrodes 32 each having the width W2 smaller than the width W1. The plurality of individual electrodes are arranged in the pattern in which the basic pattern C, in which one first electrode 31, two second electrodes 32, and one first electrode 31 are arranged sequentially in this order in the X-axis direction, is repeatedly arranged along the X-axis direction.

With such a configuration, printing of a width corresponding to one dot at 300dpi can be performed by energizing one first electrode 31 or two adjacent second electrodes 32. In addition, printing of a width corresponding to one dot at 200dpi can be performed by energizing one first electrode 31 and one second electrode 32 adjacent to each other.

Further, in the second mode (200 dpi), when printing is simply performed at the same printing speed V1 as in the first mode (300 dpi), a printing size in the printing direction (sub-scanning direction) becomes shorter than a size of one dot in the printing direction (sub-scanning direction) at 200 dpi, as illustrated in FIG. 7B, and gaps may be generated between dots.

Therefore, in the first mode (300dpi), the controller 101 sets the printing speed to the printing speed V1 based on 300 dpi and sets a number of energizations to the heat-generator per dot to be one. On the other hand, in the second mode (200 dpi), the controller 101 maintains the printing speed at the same printing speed V1 as in the first mode and sets the number of energizations to the heat-generator per dot to be two.

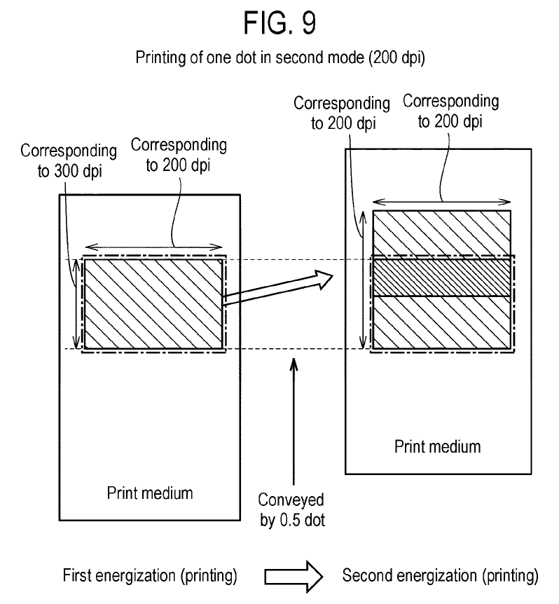

FIG. 9 is a diagram illustrating a control image according to the number of energizations in the second mode (200dpi). In the second mode, the number of energizations to the heat-generator per dot is set to be two. Specifically, after the first energization (printing) is performed, the second energization (printing) is performed at a time point when the print medium has been conveyed by 0.5 dot. With this configuration, the printing size in the sub-scanning direction per dot in the second mode becomes longer compared to a case where the number of energizations is set to be one, and a printing size is adjusted to a size of one dot at 200dpi. As a result, the generation of gaps between dots is suppressed and printing appropriate for 200dpi can be performed.

By performing the second energization at a time point when the print medium is conveyed by 0.5 dot after the first energization, a portion at which the energizations partially overlap is generated. However, it is considered that such overlapping causes no particular problem when color development of the overlapping portion is good. Alternatively, conveyance by 0.75 dot in the sub-scanning direction may be performed twice.

As described above, printing at the two types of resolutions of 200dpi and 300dpi can be performed with a single thermal print head 1. As a result, the user of the thermal printer 100 can perform printing at the two types of resolutions of 200dpi and 300dpi without performing an operation of replacing the thermal print head 1.

Further, the thermal print head 1 according to the present embodiment can reduce manufacturing costs and manufacturing workload as compared to a case where only fine-pitch second electrodes 32 are provided as the plurality of individual electrodes. A thermal print head including only fine-pitch second electrodes 32 as the plurality of individual electrodes is capable of performing fine printing corresponding to 600 dpi by energizing one second electrode 32, and is also capable of performing printing at the two types of resolutions of 200dpi and 300dpi by energizing two or three adjacent second electrodes 32. However, in order to provide a fine pattern corresponding to 600dpi, a more expensive control circuit is required and the number of connection wires or the like increases, resulting in significantly higher manufacturing costs. Moreover, the number of connection processes for the connection wires increases and processing difficulty also increases, thereby increasing the manufacturing workload. In contrast, the thermal print head 1 according to the present embodiment includes both the second electrodes 32 and the first electrodes 31 having a greater width than the second electrodes 32. Therefore, the thermal print head 1 according to the present embodiment can reduce the number of fine-pitch second electrodes 32 as compared to the case where only the second electrodes 32 are provided, thereby making it possible to reduce manufacturing costs and manufacturing workload.

### Modification 1

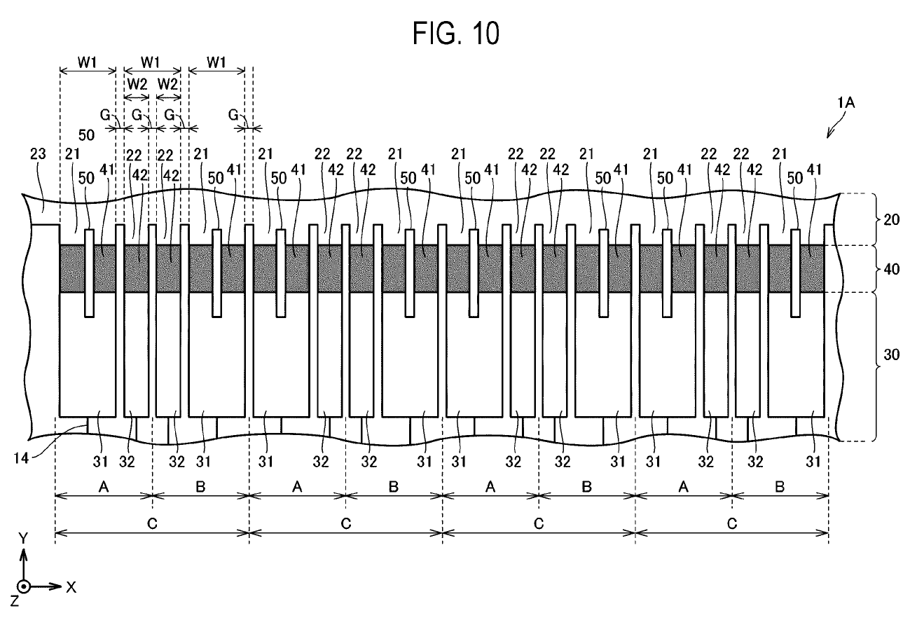

FIG. 10 is a partially enlarged plan view illustrating a main part of a thermal print head 1A according to Modification 1. The thermal print head 1A is obtained by adding a plurality of slits 50 to the above-described thermal print head 1. Other configurations of the thermal print head 1A are the same as those of the above-described thermal print head 1.

The plurality of slits 50 are respectively formed in the plurality of first heat-generators 41. Each slit 50 is formed at a center in the X-axis direction of each first heat-generator 41 and extends in the Y-axis direction. With this configuration, a difference between a temperature distribution of the first heat-generators 41 in contact with the first electrodes 31 and a temperature distribution of the second heat-generators 42 in contact with the second electrodes 32 can be reduced.

In general, both the temperature distribution of the first heat-generators 41 and the temperature distribution of the second heat-generators 42 have a circular or elliptical shape in which a central portion, where heat is less likely to dissipate, has the highest temperature and the temperature decreases toward a peripheral portion. However, in a case in which no slit 50 is provided, since the width W1 of the first heat-generators 41 is approximately twice the width W2 of the second heat-generators 42, the temperature distribution of the first heat-generators 41 may become more non-uniform overall than the temperature distribution of the second heat-generators 42.

In the thermal print head 1A according to Modification 1, by providing the slit 50 at the center in the X-axis direction of each first heat-generator 41 to bisect the first heat-generator 41, the temperature distribution of the first heat-generators 41 can be made more uniform, and the difference between the temperature distribution of the first heat-generators 41 and the temperature distribution of the second heat-generators 42 can be reduced. As a result, a difference between printing shapes formed by the first heat-generators 41 and printing shapes formed by the second heat-generators 42 can be reduced.

FIG. 10 illustrates an example in which the slits 50 are formed in all of the plurality of first heat-generators 41. However, the slits 50 may be formed in only some of the plurality of first heat-generators 41. For example, among the plurality of first heat-generators 41, a first heat-generator 41 disposed at an end in the X-axis direction tends to allow heat to dissipate more easily than the other first heat-generators 41. Therefore, the slit 50 may not be provided in such a first heat-generator 41.

### Modification 2

In the above-described embodiment, an example is illustrated in which the width (size in the X-axis direction) of the first electrode 31 is constant at the width W1 regardless of a position in the Y-axis direction and the width of the second electrode 32 is constant at the width W2 regardless of the position in the Y-axis direction.

However, as long as a width of a portion of the first electrode 31 adjacent to the first heat-generator 41 is the width W1, the width of the first electrode 31 is not necessarily limited to being constant at the width W1 regardless of the position in the Y-axis direction. Similarly, as long as a width of a portion of the second electrode 32 adjacent to the second heat-generator 42 is the width W2, the width of the second electrode 32 is not necessarily limited to being constant at the width W2 regardless of the position in the Y-axis direction. For example, the first electrode 31 may be configured such that the width of the first electrode 31 decreases toward an end in the negative Y-axis direction (toward the driver circuit 5), or the second electrode 32 may be configured such that the width of the second electrode 32 decreases toward the end in the Y-axis direction (toward the driver circuit 5).

Hereinafter, various aspects of the present disclosure will be collectively described as supplementary notes.

### Supplementary Notes

### Supplementary Note 1

A thermal print head includes:

a substrate;

a common electrode disposed on a surface of the substrate and extending in a first direction;

a plurality of individual electrodes arranged on the surface of the substrate in the first direction and respectively disposed at positions spaced apart from the common electrode by a predetermined distance in a second direction perpendicular to the first direction; and

a plurality of heat-generators respectively disposed between the common electrode and the plurality of individual electrodes,

wherein the plurality of individual electrodes includes:

a plurality of first electrodes each having, at a portion adjacent to a corresponding one of the heat-generators, a first value as a size in the first direction; and

a plurality of second electrodes each having, at a portion adjacent to a corresponding one of the heat-generators, a second value smaller than the first value as a size in the first direction, and

wherein the plurality of individual electrodes are arranged in a pattern in which a basic pattern is repeated along the first direction, wherein in the basic pattern, one of the first electrodes, two of the second electrodes, and one of the first electrodes are arranged sequentially in this order along the first direction.

### Supplementary Note 2

The thermal print head of Supplementary Note 1, wherein the first value substantially matches a sum of a value larger than the second value and a size of a gap between adjacent ones of the individual electrodes in the first direction.

### Supplementary Note 3

The thermal print head of Supplementary Note 1 or 2, wherein the plurality of heat-generators includes:

a plurality of first heat-generators respectively disposed between the common electrode and the plurality of first electrodes; and

a plurality of second heat-generators respectively disposed between the common electrode and the plurality of second electrodes.

### Supplementary Note 4

The thermal print head of Supplementary Note 3, wherein a slit extending in the second direction is formed at a center of at least one of the plurality of first heat-generators in the first direction.

### Supplementary Note 5

The thermal print head of any one of Supplementary Notes 1 to 4, further includes a driver circuit including a plurality of switching elements respectively connected to the plurality of individual electrodes.

### Supplementary Note 6

A thermal printer includes:

the thermal print head of Supplementary Note 5; and

a controller configured to perform printing on a print medium by controlling states of the plurality of switching elements of the driver circuit to energize the plurality of heat-generators.

### Supplementary Note 7

The thermal printer of Supplementary Note 6, wherein the controller is capable of switching between a first mode in which a printing resolution is a first resolution and a second mode in which the printing resolution is a second resolution lower than the first resolution, and

wherein the controller is further configured to:

in the first mode, perform printing of one dot by turning on one of the switching elements connected to one of the first electrodes, or two of the switching elements respectively connected to two adjacent ones of the second electrodes; and

in the second mode, perform printing of one dot by turning on two of the switching elements respectively connected to one of the first electrodes and one of the second electrodes, which are adjacent to each other.

### Supplementary Note 8

The thermal printer of Supplementary Note 7, wherein the controller is further configured to:

in the first mode, set a printing speed to a first speed and set a number of energizations per dot to one; and

in the second mode, maintain the printing speed at the first speed and set the number of energizations per dot to two.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A thermal print head comprising:
a substrate;
a common electrode disposed on a surface of the substrate and extending in a first direction;
a plurality of individual electrodes arranged on the surface of the substrate in the first direction, and respectively disposed at positions spaced apart from the common electrode by a predetermined distance in a second direction perpendicular to the first direction; and
a plurality of heat-generators respectively disposed between the common electrode and the plurality of individual electrodes,
wherein the plurality of individual electrodes includes:
a plurality of first electrodes each having, at a portion adjacent to a corresponding one of the heat-generators, a first value as a size in the first direction; and
a plurality of second electrodes each having, at a portion adjacent to a corresponding one of the heat-generators, a second value smaller than the first value as a size in the first direction, and
wherein the plurality of individual electrodes are arranged in a pattern in which a basic pattern is repeated along the first direction, wherein in the basic pattern, one of the first electrodes, two of the second electrodes, and one of the first electrodes are arranged sequentially in this order along the first direction.

2. The thermal print head of claim 1, wherein the first value substantially matches a sum of a value larger than the second value and a size of a gap between adjacent ones of the individual electrodes in the first direction.

3. The thermal print head of claim 1, wherein the first value substantially matches a sum of a value that is twice the second value and a size of a gap between the adjacent ones of the individual electrodes in the first direction.

4. The thermal print head of claim 1, wherein the plurality of heat-generators includes:
a plurality of first heat-generators respectively disposed between the common electrode and the plurality of first electrodes; and
a plurality of second heat-generators respectively disposed between the common electrode and the plurality of second electrodes.

5. The thermal print head of claim 4, wherein a slit extending in the second direction is formed at a center of at least one of the plurality of first heat-generators in the first direction.

6. The thermal print head of claim 1, further comprising a driver circuit including a plurality of switching elements respectively connected to the plurality of individual electrodes.

7. A thermal printer comprising:
the thermal print head of claim 6; and
a controller configured to perform printing on a print medium by controlling states of the plurality of switching elements of the driver circuit to energize the plurality of heat-generators.

8. The thermal printer of claim 7, wherein the controller is capable of switching between a first mode in which a printing resolution is a first resolution and a second mode in which the printing resolution is a second resolution lower than the first resolution, and
wherein the controller is further configured to:
in the first mode, perform printing of one dot by turning on one of the switching elements connected to one of the first electrodes, or two of the switching elements respectively connected to two adjacent ones of the second electrodes; and
in the second mode, perform printing of one dot by turning on two of the switching elements respectively connected to one of the first electrodes and one of the second electrodes, which are adjacent to each other.

9. The thermal printer of claim 8, wherein the controller is further configured to:
in the first mode, set a printing speed to a first speed and set a number of energizations per dot to one; and
in the second mode, maintain the printing speed at the first speed and set the number of energizations per dot to two.
